(19) United States
(12) Patent Application Publication
(10) Pub. No.: US 2003/0202001 A1
(43) Pub. Date: Oct. 30, 2003

(54) Information processing apparatus

(75) Inventors: Shin Takeuchi, Kanagawa (JP); Kazuyuki Tsukamoto, Kanagawa (JP); Katsumi Sakamaki, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/384,539

(22) Filed: Mar. 11, 2003

(30) Foreign Application Priority Data
Apr. 26, 2002 (JP) 2002-126922

(51) Int. Cl. G09G 5/00

(52) U.S. Cl. 345/700

(57) ABSTRACT

In an information processing apparatus, when an operator operates an input device to move a movable member from bottom to up with the thumb, the initial non-connected state is transferred to such a state that connection to the network starts to be established. When the movable member is further moved to reach another position, connection to another apparatus through the network starts to be established. According to the transfer of the connection state, haptic stimulation corresponding to the respective connection states at the respective points of time is presented by the connection presenting means to the stimulation presenting device. The haptic stimulation presented to the stimulation presenting device is force sense or vibration applied to the forefinger of the operator touching the device.

The present disclosure relates to the subject matter contained in Japanese Patent Application No. 2002-126922 filed Apr. 26, 2002, which is incorporated herein by reference in its entirety.

### BACKGROUND OF THE INVENTION

1. Field of the Invention

The present invention relates to an information processing apparatus capable of communicating another apparatus through a network.

2. Description of the Related Art

An information processing apparatus (for example, a personal computer) has an input device for receiving an input instruction made by an operator (for example, a keyboard and a mouse) and an image displaying device for displaying an image, in addition to a main unit having a CPU and a memory. When the input device receives an input instruction made by an operator, the information processing apparatus carries out prescribed processing by the main unit based on the input instruction, and a result of the processing is displayed by the image displaying device. While there are some cases where the information processing apparatus is used solely, it may communicate with another apparatus (for example, a server apparatus and an information processing apparatus of another operator) connected through a network.

In order to connect an information apparatus to another apparatus through a network, it is necessary to carry out required procedures for connecting. In the conventional connection procedures, an operator displays a list of connection sites (for example, lists of web sites and names of other operators) on an image displaying device of the information processing apparatus, and a desired connection site is selected from the list of connection sites by making an input instruction to the input device, whereby a connection to the selected connection site is requested. Upon selecting a desired connection site from the list of connection sites, the operator operates a mouse as the input device to move a mouse cursor to a displayed position of the desired connection site in the list of connection sites displayed on the image displaying device, and then clicks a mouse button.

In the case where a desired connection site is selected from a list of connection sites by clicking a mouse as in the foregoing, there are cases where an undesired connection site is improperly selected from the list of connection sites by clicking a mouse. Before actually connecting to the undesired connection site, such a message is displayed on the image displaying device that request confirmation as to whether or not the selected connection site is desired one. Subsequently, in the case where the selected connection site is desired one, the operator clicks the mouse on an “OK” column on the screen to make an input instruction accordingly to the input device. The connection to the connection site is thus attained in this manner.

In the case where an information processing apparatus a of an operator A requests connection to an information processing apparatus b of an operator B, the connection request is sent from the information processing apparatus a to the information processing apparatus b as a counterpart. The information processing apparatus b displays the fact that the connection request is sent from the information processing apparatus a on the image displaying device. The operator B, for example, clicks a mouse on an “OK” column on the screen to make an input instruction to allow the connection request of the operator A to the input device. The connection between the information processing apparatus a of the operator A and the information processing apparatus b of the operator B is thus established in this manner.

However, these procedures are different from communications among peoples in the real world, and therefore, it is difficult that the procedures are intuitively understood. Furthermore, the similar problem arises in the case where the connection is released according to the same procedures as the foregoing procedures for establishing the connection.

### SUMMARY OF THE INVENTION

The invention has been developed for solving the problems, and an object thereof is to provide an information processing apparatus that can provide intuitive understanding of procedures for establishing (or releasing) connection and can prevent an improper establishment (or release) of connection.

The invention relates to an information processing apparatus for communicating with another apparatus through a network, and the information processing apparatus contains (1) an input device for receiving an input instruction; (2) a stimulation presenting device for presenting haptic stimulation; and (3) a connection state presenting means for presenting haptic stimulation, which corresponds to a connection state with a connected apparatus, to the stimulation presenting device, upon communicating through the network based on the input instruction received by the input device.

According to the information processing apparatus, upon making an input instruction to the input device through an operation by an operator, communication is carried out through the network based on the input instruction received by the input device. Upon carrying out communication, haptic stimulation is presented by the stimulation presenting device corresponding to the connection state to the connected site through the connection state presenting means. The operator can receive the haptic stimulation presented by the stimulation presenting device, whereby the operator can intuitively understand the procedures for establishing (or releasing) the connection to prevent an improper establishment (or release) of connection.

It is preferred in the information processing apparatus according to the invention that the input device receives a movement of a movable member as the input instruction, and the stimulation presenting device presents the movement of the movable member as the haptic stimulation. In this case, an operator can touch the movable member, for example, with one finger to make an input instruction by moving the movable member as one constitutional component of the input device with the finger, and at the same time, the operator can receive haptic stimulation by the finger presented by the movable member as one constitutional component of the stimulation presenting device.

It is also preferred in the information processing apparatus according to the invention that the apparatus further contains an image displaying device for displaying an image, and the connection state presenting means displays an image corresponding to the connection state on the image displaying device. It is also preferred that the apparatus further contains an audio output device for outputting audio, and the connection state presenting means outputs audio corresponding to the connection state from the audio output device. In these cases, an image corresponding to the connection state is displayed on the image displaying device, or in alternative, audio corresponding to the connection state is output from the audio output device. An operator can further intuitively understand the procedures for establishing (or releasing) connection by the image or the audio, whereby an improper establishment (or release) of connection can be further effectively prevented.

It is also preferred in the information processing apparatus according to the invention that the stimulation presenting device is capable of presenting multistage or multidimensional haptic stimulation, and the connection state presenting means presents a certain stage of dimensional haptic stimulation corresponding to the connection state to the stimulation presenting device. It is also preferred that the input device is capable of receiving a multistage or multidimensional input instruction. In these cases, an operator receives multistage or multidimensional haptic stimulation presented by the stimulation presenting device through the connection state presenting means, or in alternative, makes a multistage or multidimensional input instruction to the input device, whereby the operator can further intuitively understand the procedures for establishing (or releasing) connection by the image or the audio, and an improper establishment (or release) of connection can be further effectively prevented.

It is also preferred in the information processing apparatus according to the invention that the image displaying device displays an image presenting a state of the apparatus connected through the network, and the connection state presenting means changes the image displayed on the image displaying device corresponding to the connection state. It is also preferred that the image displaying device displays an image presenting a state of the apparatus connected through the network, and the connection state presenting means changes the image displayed on the image displaying device corresponding to the input instruction received by the input device. In these cases, an image presenting a state of the apparatus connected through the network is displayed on the image displaying device, and the image is changed corresponding to the connection state or corresponding to the input instruction received by the input device. An operator observes the image, whereby the operator can further intuitively understand the procedures for establishing (or releasing) connection by the image or the audio, and an improper establishment (or release) of connection can be further effectively prevented.

It is also preferred in the information processing apparatus according to the invention that the input device further contains an image displaying device for displaying a cursor at a position on a screen based on the input instruction received by the input device, and the connection state upon communicating the apparatus connected through the network is changed based on the position of the cursor on the screen. It is also preferred that the image displaying device displays an image presenting the apparatus connected through the network, and the connection state presenting means presents haptic stimulation corresponding to a relative positional relationship between the image presenting the apparatus and the position of the cursor on the screen to the stimulation presenting device. It is further preferred that the image displaying device restricts a movable region of the position of the cursor on the screen based on the haptic stimulation presented by the stimulation presenting device. In these cases, a cursor is displayed at the position on the screen of the image displaying device based on the input instruction received by the input device, and haptic stimulation corresponding to the position of the cursor is presented by the stimulation presenting device, or in alternative, the movable region of the position of the cursor is restricted based on the haptic stimulation. An operator observes the movement of the cursor on the screen, whereby the operator can further intuitively understand the procedures for establishing (or releasing) connection by the image or the audio, and an improper establishment (or release) of connection can be further effectively prevented.

The invention also relates to an information processing system containing a plurality of the information processing apparatuses. When the plural information processing apparatuses contained in the information processing system are establishing (or releasing) connection to each other, the apparatuses respectively present haptic stimulation by the stimulation presenting device corresponding to the connection state to the connected apparatuses as described in the foregoing. Therefore, an operator can intuitively understand the procedures for establishing (or releasing) the connection among the plural information processing apparatuses to prevent an improper establishment (or release) of connection.

### BRIEF DESCRIPTION OF THE DRAWINGS

FIG. 1 is a block diagram showing a constitution of an information processing apparatus 1 according to a first embodiment;

FIG. 2 is an outline view showing the information processing apparatus 1 according to the first embodiment;

FIG. 3 is a block diagram showing a constitution of an information processing apparatus 2 according to a second embodiment;

FIG. 4 is an outline view showing the information processing apparatus 2 according to the second embodiment;

FIGS. 5A to 5D are diagrams showing examples of the relationship between the displacement and the haptic stimulation in the movable member 24 of the information processing apparatus 2 according to the second embodiment;

FIG. 6 is a block diagram showing a constitution of an information processing apparatus 3 according to a third embodiment;

FIG. 7 is an outline view showing the information processing apparatus 3 according to the third embodiment;

FIG. 8 is a diagram showing an example of the relationship between the displacement and the haptic stimulation in the movable member 34 of the information processing apparatus 3 according to the third embodiment;

FIG. 9 is a block diagram showing a constitution of an information processing apparatus 4 according to a fourth embodiment;

FIG. 10 is an outline view showing the information processing apparatus 4 according to the fourth embodiment;

FIG. 11 is an outline view showing an information processing apparatus 5 according to a fifth embodiment;

FIG. 12 is a cross sectional view showing a device 100 contained in the information processing apparatus 5 according to the fifth embodiment;

FIG. 13 is a block diagram showing a device 100 contained in the information processing apparatus 5 according to the fifth embodiment;

FIGS. 14A and 14B are detailed structural diagrams showing a fixed member 111 and a movable member 112 of a device 100 contained in the information processing apparatus 5 according to the fifth embodiment;

FIG. 15 is a plane view showing a haptic stimulation presenting mechanism of the device 100 contained in the information processing apparatus 5 according to the fifth embodiment;

FIG. 16 is a cross sectional view showing a sliding mechanism of the fixed member 111 and the movable member 112 in the device 100 contained in the information processing apparatus 5 according to the fifth embodiment;

FIG. 17 is a cross sectional view showing the pressure sensitive part 120 in the device 100 contained in the information processing apparatus 5 according to the fifth embodiment;

FIG. 18 is a cross sectional view showing the position detecting sensor 114 in the device 100 contained in the information processing apparatus 5 according to the fifth embodiment;

FIG. 19 is a diagram showing an example of an image displayed on the image displaying device 55 contained in the information processing apparatus 5 according to the fifth embodiment;

FIG. 20 is a diagram showing an example of an image displayed on the image displaying device 55 contained in the information processing apparatus 5 according to the fifth embodiment;

FIG. 21 is a diagram showing an example of an image displayed on the image displaying device 55 contained in the information processing apparatus 5 according to the fifth embodiment;

FIG. 22 is a diagram showing an example of an image displayed on the image displaying device 55 contained in the information processing apparatus 5 according to the fifth embodiment;

FIG. 23 is a diagram showing an example of an image displayed on the image displaying device 55 contained in the information processing apparatus 5 according to the fifth embodiment;

FIG. 24 is a diagram showing an example of an image displayed on the image displaying device 55 contained in the information processing apparatus 5 according to the fifth embodiment;

FIG. 25 is a diagram showing an example of a cursor displayed on the image displaying device 55 contained in the information processing apparatus 5 according to the fifth embodiment;

FIG. 26 is a diagram showing an example of a cursor displayed on the image displaying device 55 contained in the information processing apparatus 5 according to the fifth embodiment;

FIG. 27 is a block diagram showing an information processing system according to the embodiment;

FIG. 28 is a diagram showing examples of images displayed on the image displaying devices of the information processing apparatuses 6 to 8 contained in the information processing system according to the embodiment; and

FIG. 29 is a diagram showing examples of images displayed on the image displaying devices of the information processing apparatuses 6 to 8 contained in the information processing system according to the embodiment.

### DETAILED DESCRIPTION OF THE PREFERRED EMBODIMENTS

Embodiments of the invention will be described in detail with reference to the attached drawings. In the descriptions of the drawings, the same symbols are attached to the same elements to omit duplicate descriptions.

(First Embodiment)

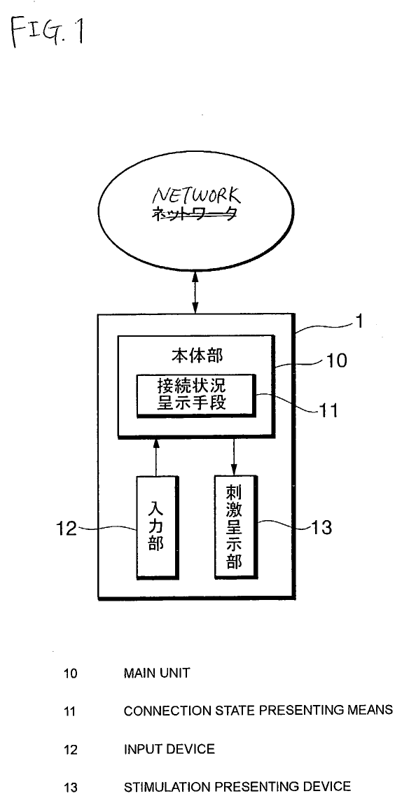

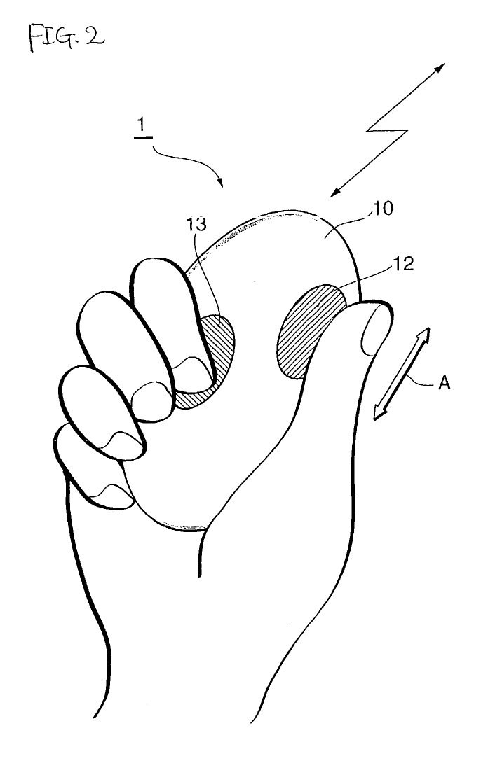

A first embodiment of the information processing apparatus according to the invention will be described. FIG. 1 is a block diagram showing a constitution of an information processing apparatus 1 according to the first embodiment. FIG. 2 is an outline view showing the information processing apparatus 1 according to the first embodiment. The information processing apparatus 1 according to this embodiment is capable of communicating with another apparatus through a network, and has a main unit 10, an input device 12 and a stimulation presenting device 13 as shown in FIG. 1. The main unit 10, the input device 12 and the stimulation presenting device 13 are integrated into such a size that can be grasped with one hand by an operator as shown in FIG. 2.

The input device 12 is capable of being operated with the thumb of the right hand of the operator who grasps the information processing apparatus 1 and receives an input instruction from the thumb. The input device 12 has a movable member capable of moving in the direction shown by the arrows A in FIG. 2, and the input instruction made by the operator is input as a displacement of the movable member. The stimulation presenting device 13 presents haptic stimulation to the forefinger of the right hand of the operator who grasps the information processing apparatus 1.

The main unit 10 is input with the input instruction received by the input device 12, and controls presentation of haptic stimulation by the stimulation presenting device 13. Furthermore, the main unit 10 has a CPU for controlling and operating the entire performance of the information processing apparatus 1, and a memory device for recording an application software, a driver software and data. The main unit 10 is capable of communicating with another apparatus through a network by controlling an interface device connected to the network. The communication between the main unit 10 and the interface device may be either wired or wireless.

The main unit 10 has a connection state presenting means 11. The connection state presenting means 11 presents haptic stimulation, which corresponds to a connection state with a connected apparatus, to the stimulation presenting device 13, upon communicating through the network based on the input instruction received by the input device 12.

For example, the case where the operator operates the input device 12 with the thumb of the right hand as shown in FIG. 2 will be described. In the case where the movable member of the input device 12 is moved from the bottom up with the thumb to reach a certain position, the initial non-connected state is transferred to such a state that connection to the network starts to be established, and in the case where the movable member is further moved to reach another position, connection to another apparatus through the network starts to be established. Upon releasing the connection, on the other hand, in the case where the movable member is moved from the top down to reach a certain position, the initial connected state is transferred to a non-connected state by releasing the connection. According to the transfer of the connection state, haptic stimulation corresponding to the respective connection states at the respective points of time is presented by the connection presenting means 11 to the stimulation presenting device 13. The haptic stimulation presented to the stimulation presenting device 13 is force sense or vibration applied to the forefinger of the operator touching the device.

Accordingly, establishment (or release) of connection to a connected site by using the information processing apparatus 1 according to this embodiment, whereby the procedures therefor can be intuitively understood to prevent improper establishment (or release) of connection.

(Second Embodiment)

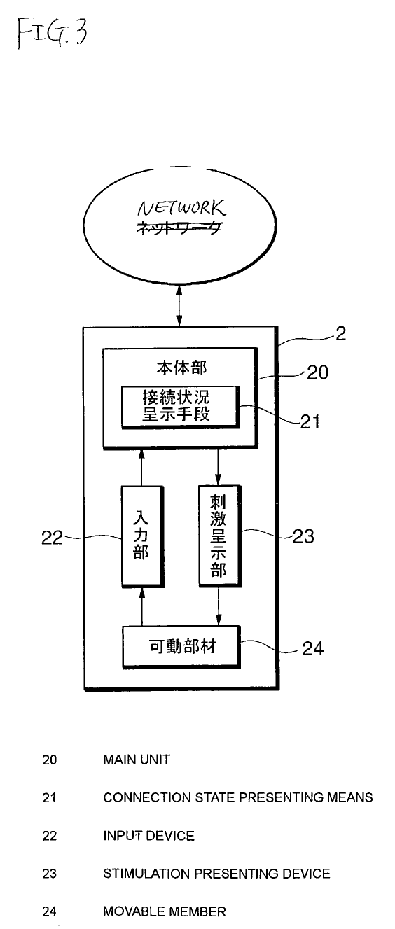

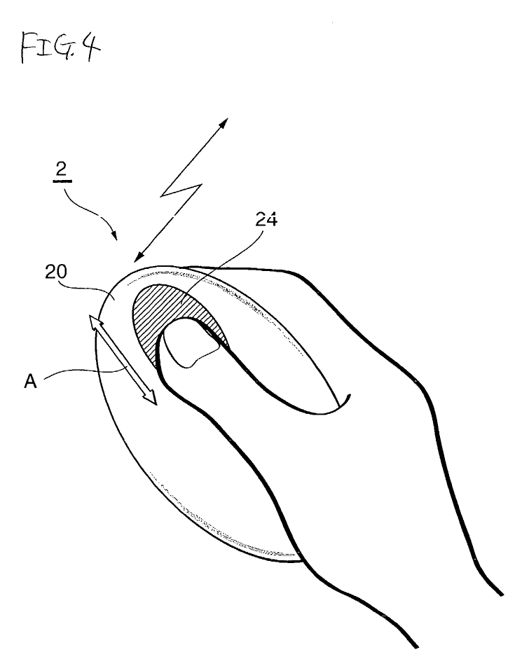

A second embodiment of the information processing apparatus according to the invention will be described. FIG. 3 is a block diagram showing a constitution of an information processing apparatus 2 according to the second embodiment. FIG. 4 is an outline view showing the information processing apparatus 2 according to the second embodiment. The information processing apparatus 2 according to this embodiment is capable of communicating with another apparatus through a network, and has a main unit 20, an input device 22, a stimulation presenting device 23 and a movable member 24 as shown in FIG. 3. The movable member 24 is one constitutional element of the input device 22, and at the same time, it is one constitutional member of the stimulation presenting device 23. The main unit 20, the input device 22, the stimulation presenting device 23 and the movable member 24 are integrated into such a size that can be grasped with one hand by an operator as shown in FIG. 4. In FIG. 4, the input device 22 and the stimulation presenting device 23 appear only with the movable member 24, which is the common constitutional element thereof.

The movable member 24 as one constitutional element of the input device 22 is capable of being operated with the thumb of the right hand of the operator who grasps the information processing apparatus 2 and receives an input instruction from the thumb. The movable element 24 is capable of moving in the direction shown by the arrows A in FIG. 4, and the input instruction made by the operator is input as a displacement of the movable member 24 to the input device 22. The movable member 24 as one constitutional element of the stimulation presenting device 23 presents haptic stimulation to the thumb of the right hand of the operator who grasps the information processing apparatus 2.

The main unit 20 is input with the input instruction received by the input device 22, and controls presentation of haptic stimulation by the stimulation presenting device 23. Furthermore, the main unit 20 has a CPU for controlling and operating the entire performance of the information processing apparatus 2, and a memory device for recording an application software, a driver software and data. The main unit 20 is capable of communicating with another apparatus through a network by controlling an interface device connected to the network. The communication between the main unit 20 and the interface device may be either wired or wireless.

The main unit 20 has a connection state presenting means 21. The connection state presenting means 21 presents haptic stimulation, which corresponds to a connection state with a connected apparatus, to the stimulation presenting device 23, upon communicating through the network based on the input instruction received by the input device 22. In this embodiment, particularly, the movable member 24 is commonly owned by the input device 22 and the stimulation presenting device 23, and therefore, the operator can make an instruction for establishment (or release) of connection to the input device 22 by moving the movable member 24, and at the same time, can realize the connection state through the haptic stimulation presented to the movable member 24.

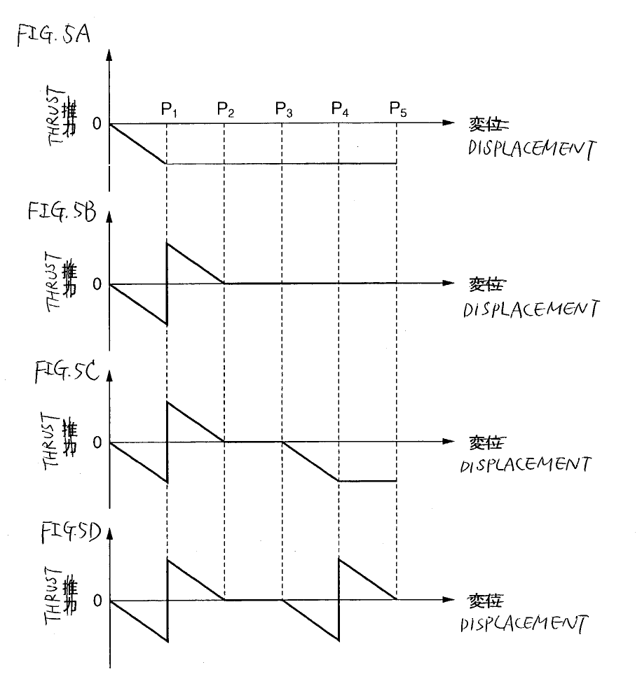

FIGS. 5A to 5D are diagrams showing examples of the relationship between the displacement and the haptic stimulation in the movable member 24 of the information processing apparatus 2 according to the second embodiment. In FIGS. 5A to 5D, the abscissa indicates the displacement amount of the movable member 24, and the ordinate indicates the thrust of the haptic stimulation presented to the movable member 24 by the connection state presenting means 21. The thrust presented in the same direction as the direction of the displacement is designated as positive thrust.

FIG. 5A shows such a case that the information processing apparatus 2 fails to connect to the network. In this case, when the operator moves the movable member 24 with the thumb until the position P₁, negative thrust rolling back the thumb of an amount proportional to the displacement amount is presented to the movable member 24. In the region beyond the position P₁, thrust rolling back the thumb of a constant amount is presented to the movable member 24. The operator can sense the state where the negative thrust is presented to the movable member, so as to realize the fact that the apparatus fails to connect to the network.

FIG. 5B shows such a case that the information processing apparatus 2 can connect to the network, but there is no counterpart apparatus to be connected through the network. In this case, when the operator moves the movable member 24 with the thumb until the position P₁, negative thrust rolling back the thumb of an amount proportional to the displacement amount is presented to the movable member 24. In the region between the position P₁ and the position P₂, positive thrust pushing forward the thumb in the direction of the displacement is presented to the movable member 24. In the region beyond the position P₂, no thrust is presented to the movable member 24. The operator can sense the thrust of the movable member that is inverted from the negative direction to the positive direction at the position P₁, so as to realize the fact that the apparatus can connect to the network, and also the operator can sense that there is no thrust in the region beyond the position P₂, so as to realize the fact that there is no counterpart apparatus to be connected through the network.

FIG. 5C shows such a case that the information processing apparatus 2 can connect to the network, and there is a counterpart apparatus to be connected through the network, but the counterpart apparatus does not respond to the connection request. In this case, when the operator moves the movable member 24 with the thumb until the position P₁, negative thrust rolling back the thumb of an amount proportional to the displacement amount is presented to the movable member 24. In the region between the position P₁ and the position P₂, positive thrust pushing forward the thumb in the direction of the displacement is presented to the movable member 24. In the region between the position P₂ and the position P₃, no thrust is presented to the movable member 24. In the region beyond the position P₃, negative thrust is presented to the movable member 24. The operator can sense the thrust of the movable member that is inverted from the negative direction to the positive direction at the position P₁, so as to realize the fact that the apparatus can connect to the network, and also the operator can sense that negative thrust is presented to the movable member 24 in the region beyond the position P₃, so as to realize the fact that there is a counterpart apparatus, but it does not respond.

FIG. 5D shows such a case that the information processing apparatus 2 can connect to the network, and there is a counterpart apparatus to be connected through the network, which responds to the connection request. In this case, when the operator moves the movable member 24 with the thumb until the position P₁, negative thrust rolling back the thumb of an amount proportional to the displacement amount is presented to the movable member 24. In the region between the position P₁ and the position P₂, positive thrust pushing forward the thumb in the direction of the displacement is presented to the movable member 24. In the region between the position P₂ and the position P₃, no thrust is presented to the movable member 24. In the region between the position P₃ and the position P₄, negative thrust is presented to the movable member 24. In the region between the position P₄ and the position P₅, positive thrust is presented to the movable member 24. At the position P₅, no thrust is presented to the movable member 24. The operator can sense the thrust of the movable member 24 that is inverted from the negative direction to the positive direction at the position P₁, so as to realize the fact that the apparatus can connect to the network, and also the operator can sense the thrust of the movable member 24 that is inverted from the negative direction to the positive direction at the position P₄, so as to realize the fact that the there is a counterpart apparatus, which responds to the connection request.

As described in the foregoing, when the operator moves the movable member 24 as one constitutional element of the input device 22, haptic stimulation corresponding to the connection state is presented to the movable member 24 as one constitutional element of the stimulation presenting device 23 by the connection state presenting means 11. In the case where connection to the network or the counterpart apparatus can be established, the first inversion of the direction of thrust of the movable member 24 notifies the operator of the fact that the connection to the network can be established, and the second inversion of the direction of thrust of the movable member 24 notifies the operator of the fact that the connection to the counterpart apparatus can be established. The inversion of the direction of thrust from the negative direction to the positive direction applies the similar haptic stimulation to the thumb of the operator as in the case where an ordinary switch is operated as on and off states. In the case where connection to the network or the counterpart apparatus cannot be established, on the other hand, the negative thrust is continuously presented to the movable member 24 to apply the similar haptic stimulation to the thumb of the operator as in the case where a switch cannot be operated as on and off states.

Accordingly, in the case where connection to the connection site is established (or released) by using the information processing apparatus 2 according to this embodiment, the procedures can be intuitively understood to prevent improper establishment (or release) of the connection. In the case where the information processing apparatus 2 is connected to the counterpart apparatus through the network, the movable members of the respective apparatuses are pushed down to respond to the connection request sent from the counterpart to establish the connection among them, and therefore, request and confirmation of connection can be attained by simple operations of the apparatuses.

(Third Embodiment)

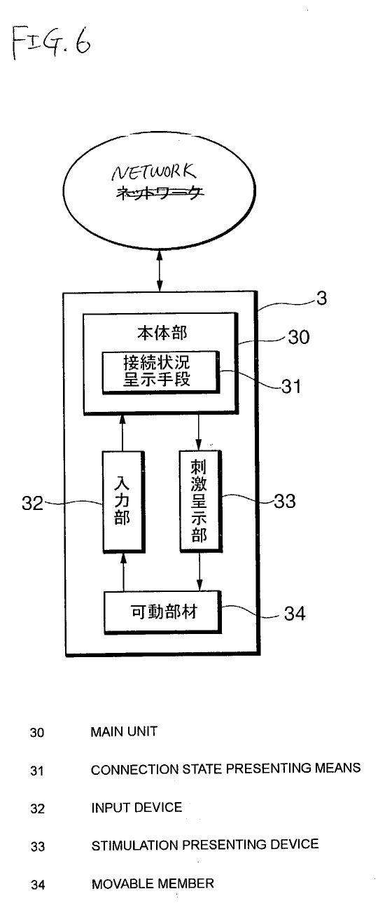

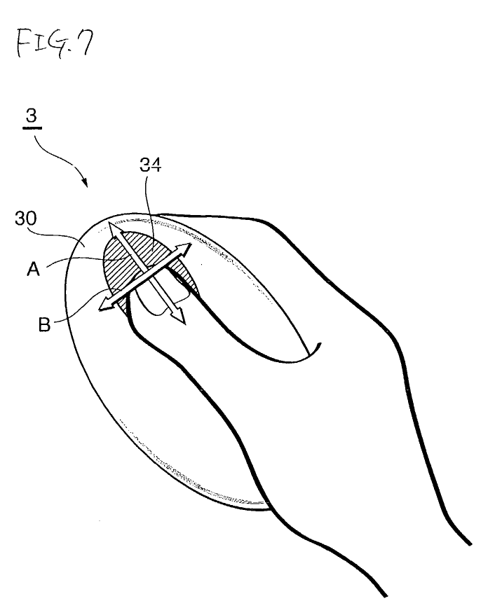

A third embodiment of the information processing apparatus according to the invention will be described. FIG. 6 is a block diagram showing a constitution of an information processing apparatus 3 according to the third embodiment. FIG. 7 is an outline view showing the information processing apparatus 3 according to the third embodiment. The information processing apparatus 3 according to this embodiment is capable of communicating with another apparatus through a network, and has a main unit 30, an input device 32, a stimulation presenting device 33 and a movable member 34 as shown in FIG. 6. The movable member 34 is one constitutional element of the input device 32, and at the same time, it is one constitutional member of the stimulation presenting device 33. The main unit 30, the input device 32, the stimulation presenting device 33 and the movable member 34 are integrated into such a size that can be grasped with one hand by an operator as shown in FIG. 7. In FIG. 7, the input device 32 and the stimulation presenting device 33 appear only with the movable member 34, which is the common constitutional element thereof.

The movable member 34 as one constitutional element of the input device 32 is capable of being operated with the thumb of the right hand of the operator who grasps the information processing apparatus 3 and receives an input instruction from the thumb. The movable element 34 is capable of moving in the two-dimensional directions shown by the arrows A and B in FIG. 7, and the input instruction made by the operator is input as a displacement of the movable member 34 to the input device 32. The movable member 34 as one constitutional element of the stimulation presenting device 33 presents haptic stimulation to the thumb of the right hand of the operator who grasps the information processing apparatus 3.

The main unit 30 is input with the input instruction received by the input device 32, and controls presentation of haptic stimulation by the stimulation presenting device 33. Furthermore, the main unit 30 has a CPU for controlling and operating the entire performance of the information processing apparatus 3, and a memory device for recording an application software, a driver software and data. The main unit 30 is capable of communicating with another apparatus through a network by controlling an interface device connected to the network. The communication between the main unit 30 and the interface device may be either wired or wireless.

The main unit 30 has a connection state presenting means 31. The connection state presenting means 31 presents haptic stimulation, which corresponds to a connection state with a connected apparatus, to the stimulation presenting device 33, upon communicating through the network based on the input instruction received by the input device 32. In this embodiment, particularly, the movable member 34 is commonly owned by the input device 32 and the stimulation presenting device 33, and therefore, the operator can make an instruction for establishment (or release) of connection to the input device 32 by two-dimensional movement of the movable member 34, and at the same time, can realize the connection state through the haptic stimulation presented to the movable member 34.

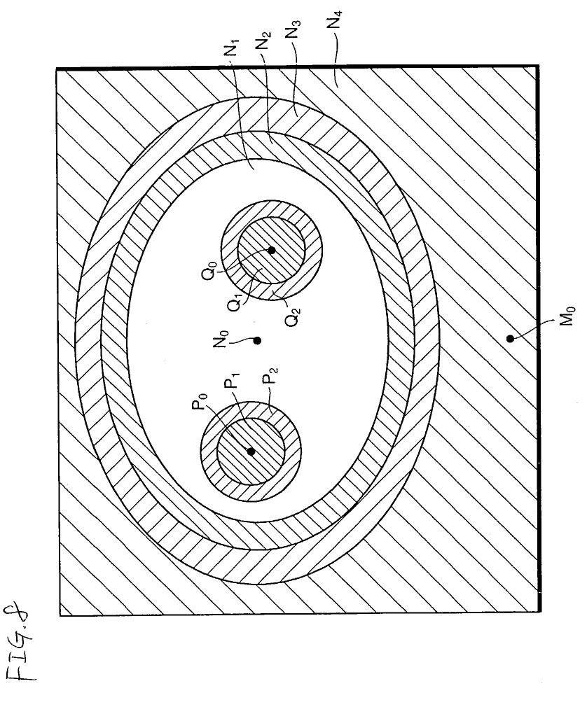

FIG. 8 is a diagram showing an example of the relationship between the displacement and the haptic stimulation in the movable member 34 of the information processing apparatus 3 according to the third embodiment. The figure shows directions of thrust presented to the movable member 34 in the respective regions on the virtual two-dimensional space, in which the movable member 34 can be moved. In the figure, the point M₀ represents the initial point of the movable member 34. The point N₀ represents the center point of the network. In the region N₁, surrounding the center point N₀, no thrust is presented to the movable member 34. In the region N₂ surrounding the region N₁, positive thrust directed to the center point N₀ is presented to the movable member 34. In the region N₃ surrounding the region N₂, negative thrust leaving from the center point N₀ is presented to the movable member 34. In the region N₄ surrounding the region N₃, thrust directed to the initial point M₀ is presented to the movable member 34.

The point P₀ inside the region N₁ represents the center point of a first counterpart apparatus. In the region P₁ surrounding the center point P₀, positive thrust directed to the center point P₀ is presented to the movable member 34. In the region P₂ surrounding the region P₁, negative thrust leaving from the center point P₀ is presented to the movable member 34. The point Q₀ inside the region N₁ represents the center point of a second counterpart apparatus. In the region Q₁, surrounding the center point Q₀, positive thrust directed to the center point Q₀ is presented to the movable member 34. In the region Q₂ surrounding the region Q₁, negative thrust leaving from the center point Q₀ is presented to the movable member 34. The regions P₁, P₂, Q₁ and Q₄ reside inside the region N₁.

When the operator moves the movable member 34 with the thumb from the initial point M₀, thrust directed to the initial point M₀ is presented to the movable member 34 in the case where the movable member 34 resides inside the region N₄ on the virtual two-dimensional space. However, when the movable member 34 enters the region N₃, negative thrust leaving from the center point N₀ of the network is presented to the movable member 34. In the case where the operator moves the movable member 34 against the negative thrust to make the movable member 34 enter the region N₂, positive thrust directed to the center point N₀ is presented to the movable member 34. When the movable member 34 enters the region N₁, no thrust is presented to the movable member 34. The inversion of the direction of thrust of the movable member 34 from the negative direction to the positive direction notifies the operator of the fact that the connection to the network is established.

In the case where operator further moves the movable member 34 with the thumb to make the movable member 34 enter the region P₂, negative thrust leaving from the center point P₀ of the first counterpart apparatus is presented to the movable member 34. In the case where the operator moves the movable member 34 against the negative thrust to make the movable member 34 enter the region P₁, positive thrust directed to the center point P₀ is presented to the movable member 34. When the movable member 34 reaches the center point P₀, no thrust is presented to the movable member 34. The second inversion of the direction of thrust of the movable member 34 from the negative direction to the positive direction notifies the operator of the fact that the connection to the counterpart apparatus is established.

The operator can comprehend the presence of two regions, i.e., the region P₂ and the region Q₂, where negative thrust is presented, by moving the movable member 34 over a wide area inside the region N1 on the virtual two-dimensional space, and therefore, the operator can realize the fact that there are two counterpart apparatuses that can be connected.

(Fourth Embodiment)

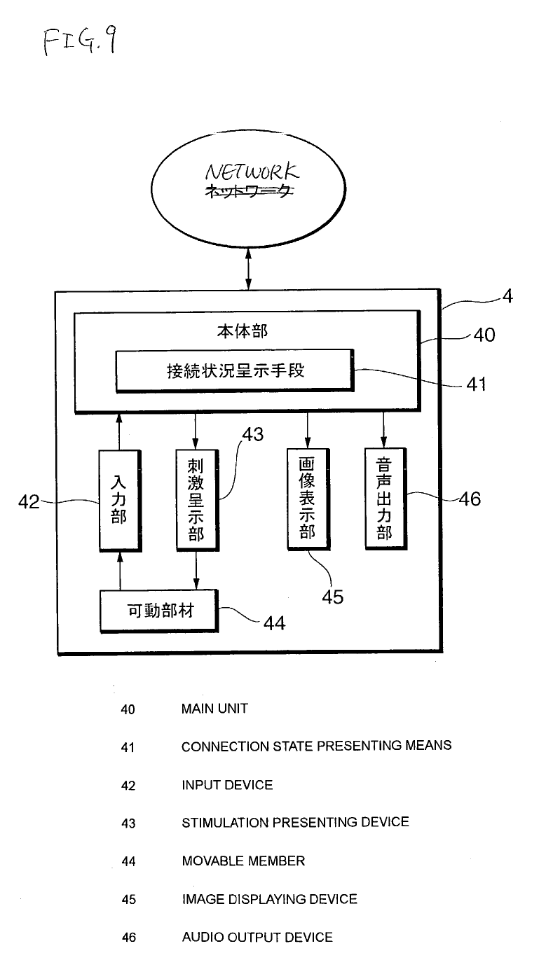

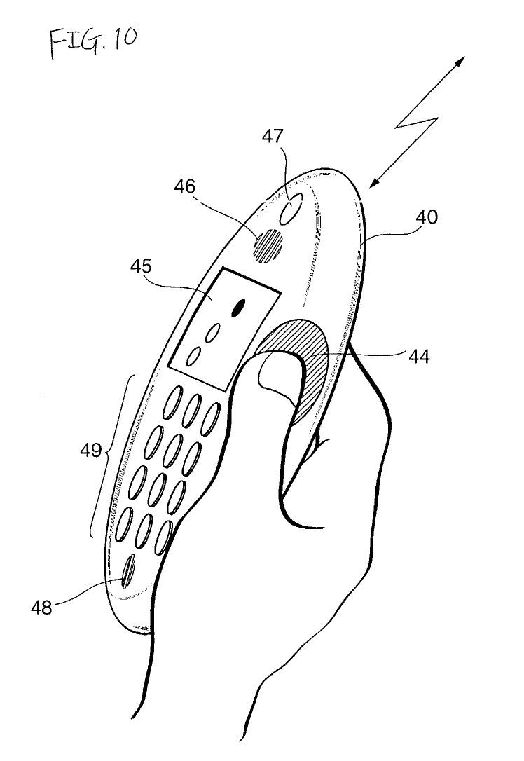

A fourth embodiment of the information processing apparatus according to the invention will be described. FIG. 9 is a block diagram showing a constitution of an information processing apparatus 4 according to the fourth embodiment. FIG. 10 is an outline view showing the information processing apparatus 4 according to the fourth embodiment. The information processing apparatus 4 according to this embodiment is capable of communicating with another apparatus through a network, and has a main unit 40, an input device 42, a stimulation presenting device 43, a movable member 44, an image displaying device 45 and an audio output device 46 as shown in FIG. 9. The movable member 44 is one constitutional element of the input device 42, and at the same time, it is one constitutional member of the stimulation presenting device 43. In this embodiment, the input device 44 not only receives an input instruction made by a movement of the movable member 44, but also contains a camera 47 for taking an image, a microphone 48 for inputting audio and plural buttons 49 as shown in FIG. 10. The foregoing constitutional elements are integrated into such a size that can be grasped with one hand by an operator.

The movable member 44 as one constitutional element of the input device 42 is capable of being operated with the thumb of the right hand of the operator who grasps the information processing apparatus 4 and receives an input instruction from the thumb. The movable element 44 is capable of moving in the two-dimensional directions, and the input instruction made by the operator is input as a displacement of the movable member 44 to the input device 42. The movable member 44 as one constitutional element of the stimulation presenting device 43 presents haptic stimulation to the thumb of the right hand of the operator who grasps the information processing apparatus 4.

The main unit 40 is input with the input instruction received by the input device 42, and controls presentation of haptic stimulation by the stimulation presenting device 43. Furthermore, the main unit 40 has a CPU for controlling and operating the entire performance of the information processing apparatus 4, and a memory device for recording an application software, a driver software and data. The main unit 40 is capable of communicating with another apparatus through a network by controlling an interface device connected to the network. The communication between the main unit 40 and the interface device may be either wired or wireless.

The main unit 40 has a connection state presenting means 41. The connection state presenting means 41 presents haptic stimulation, which corresponds to a connection state with a connected apparatus, to the stimulation presenting device 43, upon communicating through the network based on the input instruction received by the input device 42. In this embodiment, particularly, the movable member 44 is commonly owned by the input device 42 and the stimulation presenting device 43, and therefore, the operator can make an instruction for establishment (or release) of connection to the input device 42 by two-dimensional movement of the movable member 34, and at the same time, can realize the connection state through the haptic stimulation presented to the movable member 44.

The image displaying device 45 is for displaying an image, and the audio output device 46 is to outputting audio. The connection state presenting means 41 displays an image corresponding to the connection state on the image displaying device 45, and outputs audio corresponding to the connection state from the audio output device 46.

The camera 47 takes such an image as the face of the operator operating the information processing apparatus 4 to obtain an image. The microphone 48 inputs such audio as voice of the operator operating the information processing apparatus 4. The image and the audio are sent to the counterpart apparatus through the network. The plural buttons 49 are used, for example, for inputting an address of the connection site.

The behavior of the information processing apparatus 4 according to this embodiment is substantially the same as in the case of the third embodiment. Accordingly, in the case where connection to the connection site is established (or released) by using the information processing apparatus 4 according to this embodiment, the procedures can be intuitively understood to prevent improper establishment (or release) of the connection. In the case where the information processing apparatus 4 is connected to the counterpart apparatus through the network, the movable members of the respective apparatuses are pushed down to respond to the connection request sent from the counterpart to establish the connection among them, and therefore, request and confirmation of connection can be attained by simple operations of the apparatuses.

Furthermore, the information processing apparatus 4 according to this embodiment has the image displaying device 45 or the audio output device 46, and an image corresponding to the connection state to the connection site is displayed on the image displaying device 45, or in alternative, audio corresponding to the connection state to the connection site is output from the audio output device 46, by the connection state presenting means 41. Examples of the image displayed on the image displaying device 45 include an image of a virtual two-dimensional space as shown in FIG. 8, an image of a cursor presenting the position of the movable member 44, and an image indicating the property of the counterpart apparatus that can be connected. According to the constitution, the operation of connection and the confirmation of the connection state can be further easily attained.

(Fifth Embodiment)

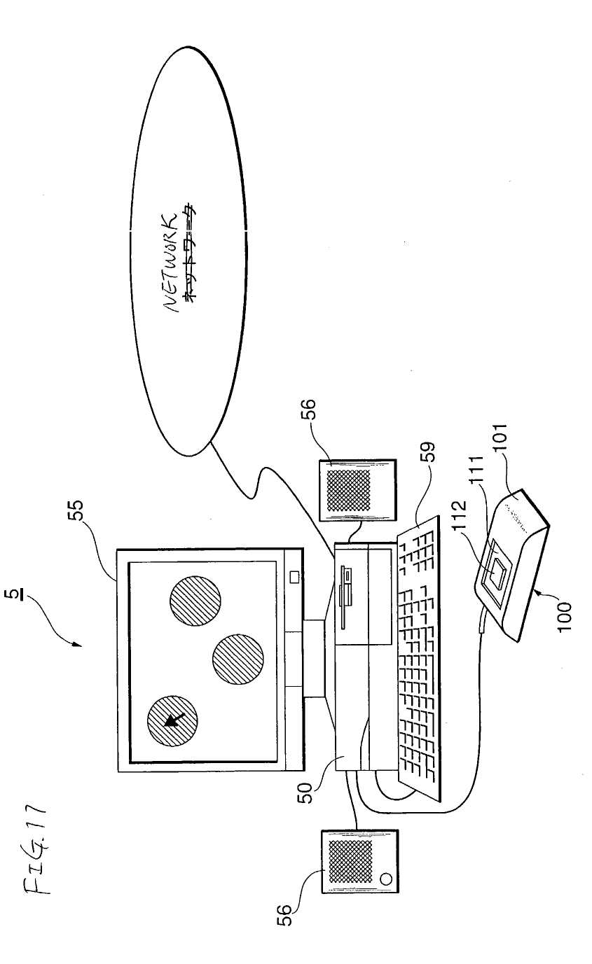

A fifth embodiment of the information processing apparatus according to the invention will be described. FIG. 11 is an outline view showing an information processing apparatus 5 according to the fifth embodiment. While the information processing apparatuses of the foregoing embodiments have small sizes through integration, the information processing apparatus 5 of this embodiment is not integrated.

The information processing apparatus 5 according to this embodiment has a main unit 50, an image displaying device 55, a pair of audio output devices (speakers) 56, a keyboard 59 and a device 100. The device 100 has both functions of an input device receiving an input instruction made by an operator and a stimulation presenting device for presenting haptic stimulation to the operator. The main unit 50 has a connection state presenting means for presenting haptic stimulation corresponding to the connection state to a connection site to the stimulation presenting device of the device 100. The connection state presenting means displays an image corresponding to the connection state on the image displaying device 55, and outputs audio corresponding to the connection state from the audio output devices 56. These elements accomplish the same functions as the corresponding elements in the fourth embodiment. The information processing apparatus 5 according to this embodiment can exert the similar effect as in the case of the fourth embodiment.

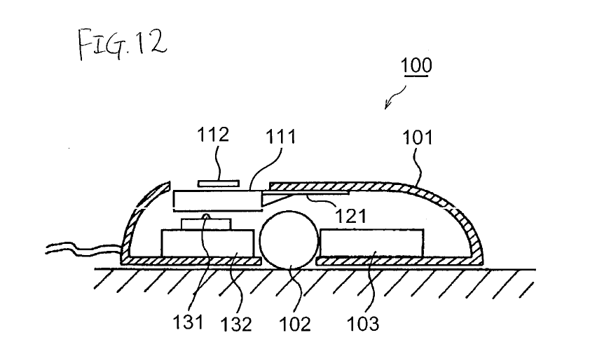

An example of the device 100 contained in the information processing apparatus 5 according to the fifth embodiment will be described with reference to FIGS. 12 to 18. The device 100 shown in these figures has a stimulation presenting device in addition to a pointing function unit (input device), which is generally used in the conventional mouse.

FIG. 12 is a cross sectional view showing the device 100. The device 100 has substantially the same configuration as the conventional mouse and has a main body 101, a ball 102 and a first displacement detecting means 103. These are such elements that realize the pointing function, which is owned by the conventional mouse. The ball 102 is rotatablly located at a bottom of the main body 101, and the ball 102 is rotated upon moving the main body 101 on a standard plane (for example, a top surface of a desk and a mouse pad). The first displacement detecting means 103 detects the rotation direction and the rotation amount of the ball with an encoder to determine the two-dimensional displacement (the movement direction and the distance) of the main body 101 with respect to the standard surface.

The device 100 also has a fixed member 111, a movable member 112 and a supporting member 121. These are such elements that constitute the stimulation presenting device. The fixed member 111 is fixed on an upper part of the main body 101 through the supporting member 121 capable of elastically bending. The movable member 112 is movable with respect to the fixed member 111.

The device 100 further has a switch 131 and a signal processing circuit 132. Upon pressing down the movable member 112, for example, with a finger of a person operating the device 100, the fixed member 111 presses down the switch 131. In other words, the switch 131 detects as to whether or not the movable member 112 is pressed down, and the signal processing circuit 132 outputs such a signal that presents as to whether or not it is pressed down.

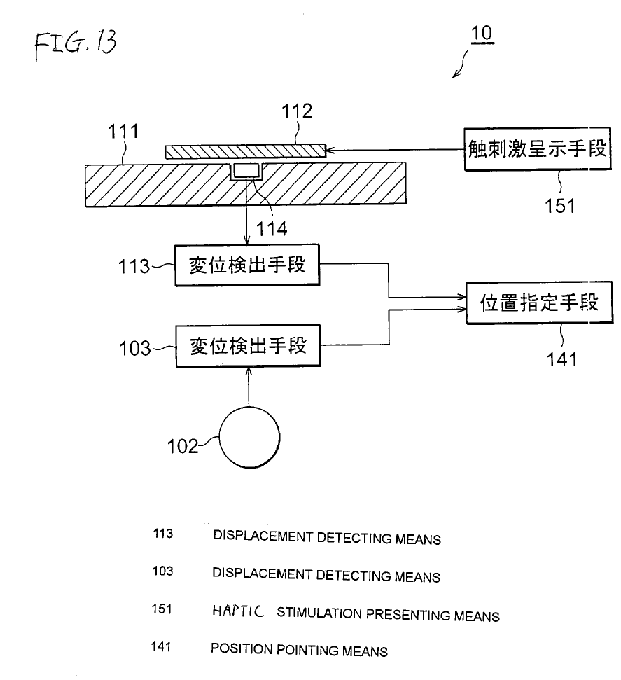

FIG. 13 is a block diagram showing the device 100. In this figure, the fixed member 111 and the movable member 112 are shown as a cross sectional view. The fixed member 111 and the movable member 112 each has a substantially plate shape, and the movable member 112 is movable with respect to the fixed member 111. The direction of movement of the movable member 112 is in parallel to the surface of the fixed member 111, and the movable member 112 can also rotate on the surface. A second displacement detecting means 113 detects the displacement (the movement direction and the distance) of the movable member 112 with respect to the fixed member 111, associated with a position detecting sensor 114.

A position pointing means 141 acquires information of an input instruction with respect to position made by an operator corresponding to the displacement of the main body 101 detected by the first displacement detecting means 103 and the displacement of the movable member 112 detected by the second displacement detecting means 113, and sends the information to the main unit 50. This is such a behavior that is based on the pointing function of the device 100. A stimulation presenting means 151 moves the movable member 112 with respect to the fixed member 111, so as to present haptic stimulation to, for example, a finger of the operator in contact with the movable member 112.

The device 100 may send to the main unit 50 either the information of the finally designated position, or in alternative, the displacement of the main body 101 detected by the first displacement detecting means 103 and the displacement of the movable member 112 detected by the second displacement detecting means 113. In the later case, the position pointing means 141 of the device 100 is provided inside the main unit 50.

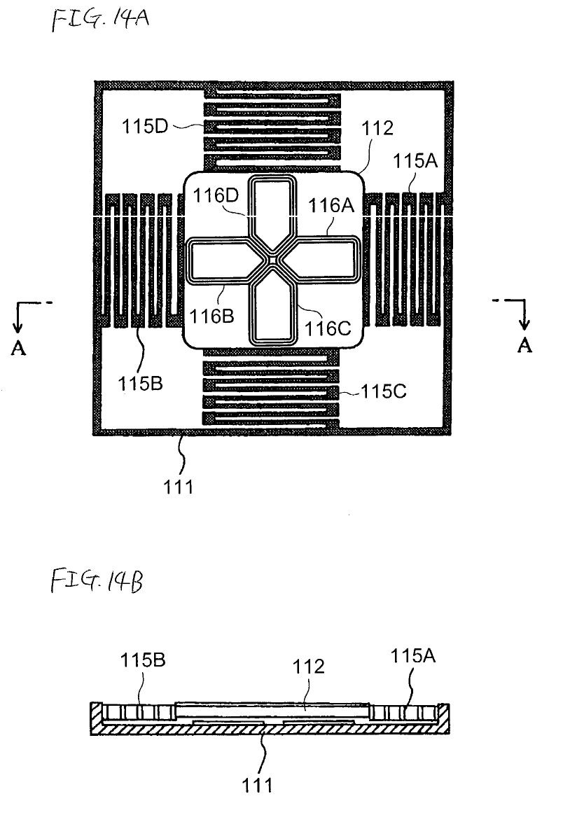

FIGS. 14A and 14B are detailed structural diagrams showing the fixed member 111 and the movable member 112 of the device 100. FIG. 14A is a plane view and FIG. 14B is a cross sectional view on line A-A in FIG. 14A. The device 100 has a fixed member 111 having a substantially plate shape having side edges protruding upward, a movable member 112 movable with respect to the fixed member 111 in a direction in parallel to a prescribed plane, and elastic members 115A to 115D provided between the side edges of the fixed member and the movable member 112 to connect them. The elastic members 115A to 115D each is a resin having elasticity or a spring and is provided at four positions around the movable member 112 in such a manner that one end of the elastic member is connected to the movable member 112, and the other end thereof is connected to one of the side edges of the fixed member 111.

Four coils 116A to 116D are fixed to the movable member 112. In the plane view shown in FIG. 14A, assuming that the center point is designated as an original point, the rightward direction is designated as an X axis direction, and the upward is designated as a Y axis direction, the coil 116A is provided over the X axis in a region with a positive X coordinate value, the coil 116B is provided over the X axis in a region with a negative X coordinate value, the coil 116C is provided over the Y axis in a region with a positive Y coordinate value, and the coil 116D is provide over the Y axis in a region with a negative Y coordinate value.

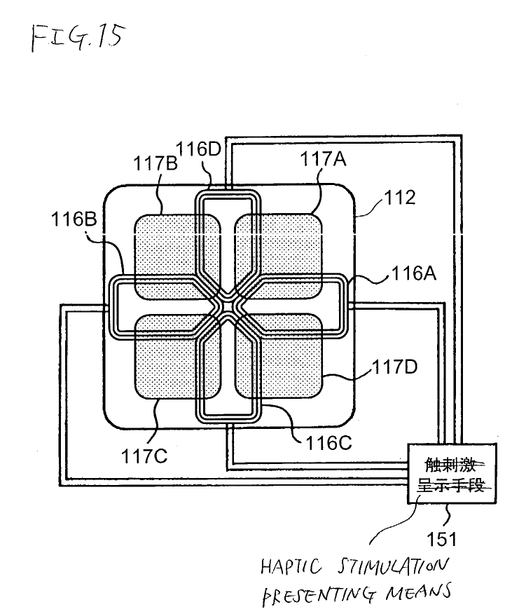

FIG. 15 is a plane view showing a haptic stimulation presenting mechanism of the device 100. Four magnets 117A to 117D are fixed to a fixed member 111. The magnet 117A is provided in a region with a positive X coordinate value and a positive Y coordinate value in such a manner that a magnetic flux thereof penetrates both the coil 116A and the coil 116D. The magnet 117B is provided in a region with a negative X coordinate value and a positive Y coordinate value in such a manner that a magnetic flux thereof penetrates both the coil 116B and the coil 116D. The magnet 117C is provided in a region with a negative X coordinate value and a negative Y coordinate value in such a manner that a magnetic flux thereof penetrates both the coil 116B and the coil 116C. The magnet 117D is provided in a region with a positive X coordinate value and a negative Y coordinate value in such a manner that a magnetic flux thereof penetrates both the coil 116A and the coil 116C. The magnets 117A and 117C among these each is arranged in such a manner the south pole thereof faces the movable member 112, and the magnets 117B and 117D each is arranged in such a manner that the north pole thereof faces the movable member 112.

In other words, the relative relationship among the coils 116A to 116D and the magnets 117A to 117D is as follows. The coil 116A is provided in such a manner that an electric current is flowed in a direction in parallel to the X axis with respect to magnetic fields made by the magnets 117A and 117D. The coil 116B is provided in such a manner that an electric current is flowed in a direction in parallel to the X axis with respect to magnetic fields made by the magnets 117B and 117C. The coil 116C is provided in such a manner that an electric current is flowed in a direction in parallel to the Y axis with respect to magnetic fields made by the magnets 117C and 117D. The coil 116D is provided in such a manner that an electric current is flowed in a direction in parallel to the Y axis with respect to magnetic fields made by the magnets 117A and 117B.

The coils 116A to 116D may be formed by using copper wire or aluminum wire for weight saving, and aluminum wire having copper plating is also preferably used. The magnets 117A to 117D are preferably those having a large coercive force and a large residual magnetic flux density, and for example, a neodymium magnet is preferably used.

The stimulation presenting means 151 can flow an electric current independently on the coils 116A to 116D, and thus mutual interactions based on the Fleming's left-hand rule among the extents and the directions of the electric currents flowing in the coils 116A to 116D and the magnetic fields produced by the magnets 117A and 117D. Accordingly, thrust is formed on each of the coils 116A to 116D, and thus the movable member 112 moves with respect to the fixed member 111 corresponding to the thrust and stress of each of the elastic members 115A to 115D. Consequently, the movable member 112 presents haptic stimulation to, for example, a finger of an operator in contact with the movable member 112.

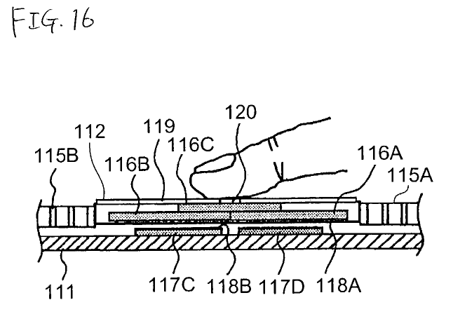

FIG. 16 is a cross sectional view showing a sliding mechanism of the fixed member 111 and the movable member 112 in the device 100. A sliding member 118A and a sliding member 118B are provided on a lower surface of the fixed member 111 having the magnets 117A to 117D fixed thereto and an upper surface of a movable member 112 having the coils 116A to 116D fixed thereto, respectively, whereby both the members are sliding on each other. A fluorine resin (for example, polytetrafluoroethylene) having a small friction coefficient and a resin and a metal impregnated with a lubricating oil are preferably used as the sliding members 118A and 118B. It is also preferred that a lubricating oil is coated between the sliding members 118A and 118B, and it is also possible that non-magnetic spherical bodies intervene therebetween to attain sliding with rotation of the spherical bodies.

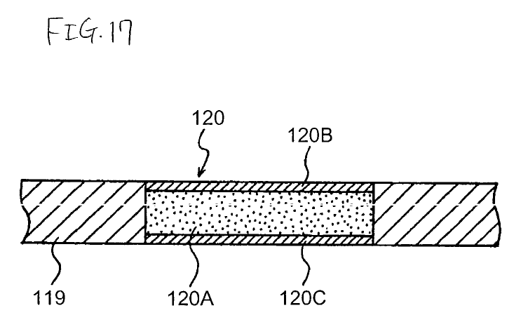

A surface layer 119 on an upper surface of the movable member 112 and a pressure-sensitive part 120 provided in the vicinity of the center of the surface layer 119 are also shown in FIG. 16, in addition to the sliding mechanism. FIG. 17 is a cross sectional view showing the pressure sensitive part 120 in the device 100. The surface layer 119 is finished to have a smooth surface, whereby a receptor, such as a finger and a palm, can be next thereto. The pressure-sensitive part 120 is for detecting the fact that a human finger or the like is in contact with the surface layer 119. The pressure-sensitive part 120 contains a pressure-sensitive electroconductive rubber 120A formed of a mixture of silicone rubber and electroconductive powder, and electroconductive plastics layers 120B and 120C sandwiching the pressure-sensitive electroconductive rubber 120A. A voltage is applied between the electroconductive plastics layer 120B and the electroconductive plastics layer 120C, and a change in electric resistance caused by a contact pressure upon contacting a human finger or the like with the pressure-sensitive part 120 is sensed to detect presence or absence of the contact. The contact detection signal output from the pressure-sensitive part 120 is sent to the stimulation resenting means 151, and in the case where the contact is confirmed, the movable member 112 is driven by the haptic stimulation presenting means 151.

In addition to the foregoing, the following methods can be used for detecting contact of a human finger or the like with the movable member 112. That is, it is also preferred that a charge accumulating part retaining prescribed electric charge by accumulation is provided in the movable member 112, and upon contacting a human finger or the like therewith, the electric charge retained in the charge accumulating part is ran off to the human finger or the like to detect change of the amount of electric charge accumulated in the charge accumulating part, whereby the contact of the human finger or the like with the movable member 112 is detected. Furthermore, it is also preferred that two electrodes having flexibility are supported to form a constant distance between the electrodes, and in the case where a human finger or the like is in contact therewith, the distance between the electrodes is changed to produce change of the capacitance present between the electrodes, which is thus sensed to detect the fact that the human finger or the like is in contact with the movable member 112. Moreover, it is also preferred that photo-accepting elements are provided on an upper surface of the movable member 112 and an upper surface of the side edges of the fixed member 111, respectively, and based on changes of the output signals from the respective photo-accepting elements, decrease of the output signal from the photo-accepting element on the upper surface of the movable member 112 is sensed to detect the fact that the human finger or the like is in contact with the movable member 112.

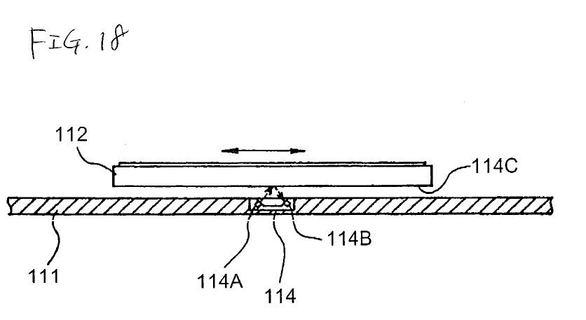

FIG. 18 is a cross sectional view showing the position detecting sensor 114 in the device 100. The position detecting sensor 114 contains a light emitting element (for example, a light emitting diode) 114A and a photo-accepting element (for example, a photodiode) 114B, which are fixed to the fixed member 111, and an optical pattern (for example, an equally spaced light and shade pattern and a checkered pattern) 114C printed on a lower surface of the movable member 112. Light emitted from the light emitting element 114A is incident on the optical pattern 114C, and light reflected by the optical pattern 114C is accepted by the photo-accepting element 114B. The amount of light accepted by the photo-accepting element 114B corresponds to the reflectivity of the optical pattern 114C at a position, on which the light emitted from the light emitting element 114A is incident.

Therefore, the amount of displacement of the movable member 112 with respect to the fixed member 111 can be detected based on change of the electric signal output from the photo-accepting element 114B corresponding to the amount of light accepted. The amount of two-dimensional displacement of the movable member 112 with respect to the fixed member 111 can be detected by providing the position detecting sensors 114 in the X axis direction and the Y axis direction, respectively. The output signal from the position detecting sensor 114 is sent to the second displacement detecting means 113, and the displacement of the movable member 112 is detected by the second displacement detecting means 113.

In addition to the foregoing, the following methods can be used for detecting the displacement of the movable member 112. That is, it is also preferred that fine concavity and convexity provided on a lower surface of the movable member 112 is irradiated with laser light to form a speckle pattern, and the speckle pattern is observed with a two-dimensional image sensor to detect the amount of two-dimensional displacement of the movable member 112 with respect to the fixed member 111. It is also preferred that a rotational body in contact with the movable member 112 is provided, the amount of rotation of the rotational body is detected by an encoder, so as to detect the amount of displacement of the movable member 112 with respect to the fixed member 111. Furthermore, it is also preferred that a light emitting element is provided one of the fixed member 111 and the movable member 112, and a two-dimensional optical position sensitive detector (PSD) element is provided on the other thereof, so as to detect the amount of two-dimensional displacement of the movable member 112 with respect to the fixed member 111.

The haptic stimulation presenting behavior of the stimulation presenting device contained in the device 100 will be described. When an electric current is flowed in the coils 116A to 116D, respectively, by driving with the haptic stimulation presenting means 151, thrust is formed in the coils 116A to 116D, respectively, according to the Fleming's left-hand rule, whereby the movable member 112 is moved.

In the case where the coils 116A and 116B are firstly considered, a magnetic field is formed in the Z axis direction perpendicular to the fixed member 111, and when an electric current is flowed in the X axis direction in the magnetic field, thrust in the Y axis direction is formed. When an electric current is flowed in the coil 116A in the clockwise direction, thrust in the +Y axis direction is formed in the coil 116A. When an electric current is flowed in the coil 116B in the anticlockwise direction, thrust in the +Y axis direction is formed in the coil 116B. The direction of the thrust can be changed by changing the direction, in which the electric current is flowed. The strength of the thrust can be changed by changing the amount of electric current.

In the case where the coils 116C and 116D are then considered in the similar manner, a magnetic field is formed in the Z axis direction perpendicular to the fixed member 111, and when an electric current is flowed in the Y axis direction in the magnetic field, thrust in the X axis direction is formed. When an electric current is flowed in the coil 116C in the clockwise direction, thrust in the +X axis direction is formed in the coil 116C. When an electric current is flowed in the coil 116D in the anticlockwise direction, thrust in the +X axis direction is formed in the coil 116D. The direction of the thrust can be changed by changing the direction, in which the electric current is flowed. The strength of the thrust can be changed by changing the amount of electric current.

In the case where it is sufficient that the movable member 112 is moved in parallel to the fixed member 111, the coil 116A and the coil 116B are connected to each other to form thrust in the same direction in both the coils 116A and 116B, and the coil 116C and the coil 116D are connected to each other to form thrust in the same direction in both the coils 116C and 116D.

Furthermore, it is also possible that thrust can be formed in such a direction that the movable member 112 is rotated with respect to the fixed member 111 with the Z axis being substantially center. That is, when an electric current is flowed in the coil 116A and the coil 116B in the clockwise direction, respectively, thrust in the +Y axis direction is formed in the coil 116A, and thrust in the −Y direction is formed in the coil 116B, whereby such a rotation moment is formed that rotates the movable member 112 in the anticlockwise direction with respect to the fixed member 111. When an electric current is flowed in the coil 116A and the coil 116B in the anticlockwise direction, respectively, thrust in the −Y axis direction is formed in the coil 116A, and thrust in the +Y direction is formed in the coil 116B, whereby such a rotation moment is formed that rotates the movable member 112 in the clockwise direction with respect to the fixed member 111. The rotation center can be changed by changing the proportion of the amounts of the electric current flowed in the coil 116A and 116B, respectively. The same can be applied to the case of the coil 116C and 116D.

The movement of the movable member 112 described in the foregoing is driven with an electric current supplied from the haptic stimulation presenting means 151 to the coils 116A to 116C, respectively. In order to attain control at this time, PD control (proportional and differential control) is used, which is made corresponding to the positional deviation and the differential value of positional deviation.

The stimulation presenting devices 23, 33, and 43 in the information processing apparatuses according to the second, third and fourth embodiments are equivalent to the stimulation presenting device of the device 100 taking out solely therefrom. The stimulation presenting device 13 of the information processing apparatus 1 according to the first embodiment has such a movable member that can move only in a one-dimensional direction, a mechanism having the same principal as the foregoing can be employed.

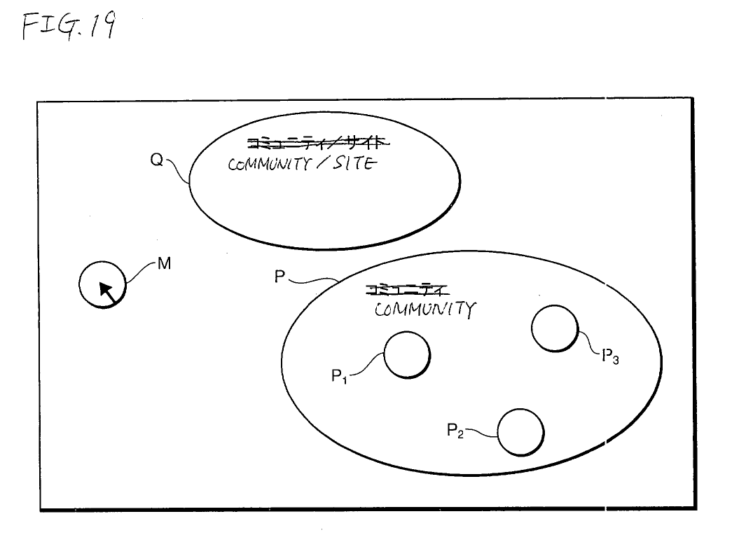

An example of procedures for connecting to a connection site will be described by using the information processing apparatus 5 according to the fifth embodiment with reference to FIGS. 19 to 24. FIGS. 19 to 24 each is a diagram showing an example of an image displayed on the image displaying device 55 contained in the information processing apparatus 5 according to the fifth embodiment.

When a person operating the information processing apparatus 5 attempts to establish connection to the network by using the keyboard 59 and the device 100, an image shown in FIG. 19 is displayed on the image displaying device 55. In the initial screen shown in the figure, a cursor M, the position of which is defined by the pointing function of the device 100, and a community P and a site Q, which are connection sites capable of being connected, are graphically displayed. Furthermore, apparatuses of other operators inside the community P are graphically displayed as circles P₁ to P₃.

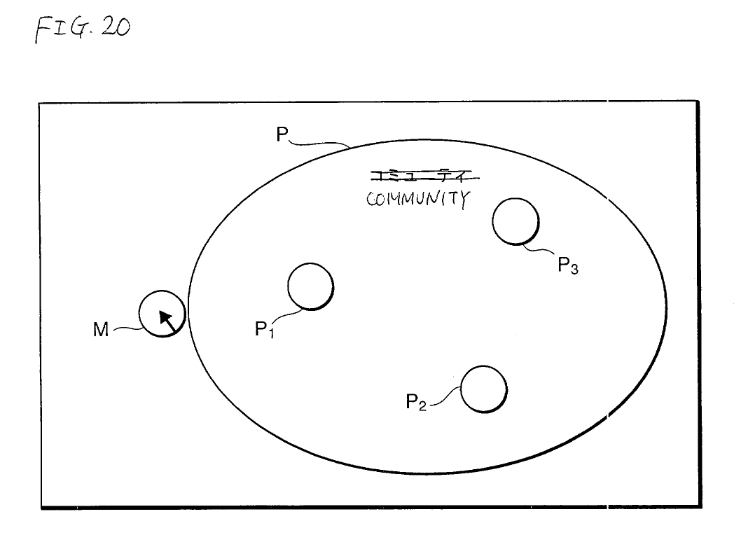

As shown in FIG. 20, when the operator moves the device 100 to make the cursor M approach the community P, a repulsive force is presented to the movable member 112 of the device 100 The repulsive force is thrust for moving the movable member 112 to the left in the case where the cursor M approaches the community P from the left as shown in the figure. When the operator further moves the movable member 112 to the right against the repulsive force, the cursor M can enter the community P (i.e., the information processing apparatus 5 is connected to the community P). The operator senses the repulsive force and moves the cursor M against the repulsive force, and thus the operator can intuitively understand the cursor M enters the community P to prevent improper establishment of connection.

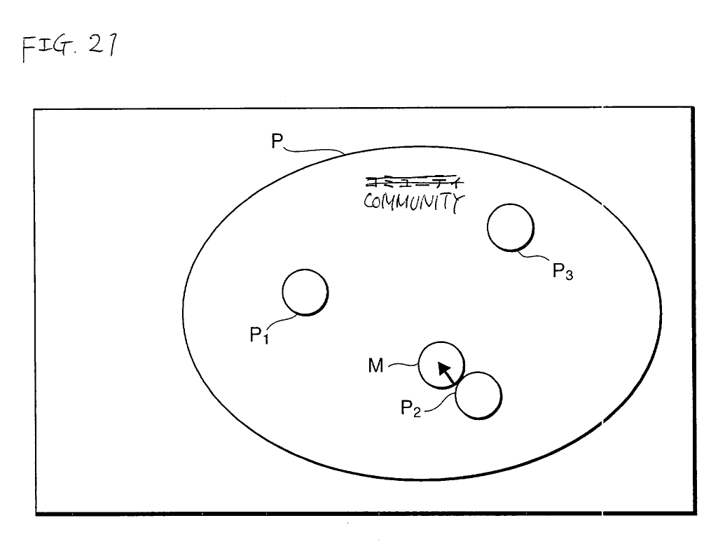

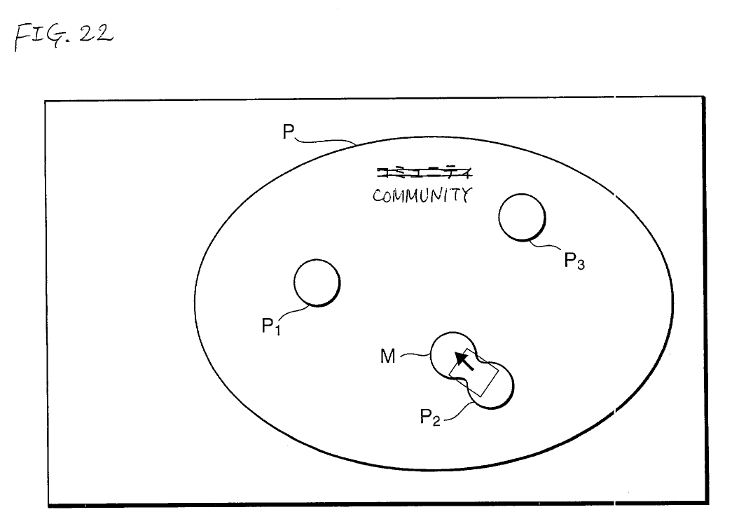

As shown in FIG. 21, when the operator moves the device 100 to make the cursor M approach the circle P₂, a repulsive force is presented to the movable member 112 of the device 100. The repulsive force is thrust for moving the movable member 112 to the upper left in the case where the cursor M approaches the circle P₂ from the upper left as shown in the figure. The similar repulsive force is presented in the apparatus of another operator represented by the circle P₂. When the operator further moves the movable member 112 to the lower right against the repulsive force, and at the same time, another operator represented by the circle P₂ carries out the same operation, the cursor M can unified with the circle P₂ (i.e., the information processing apparatus 5 is connected to the information processing apparatus of another operator represented by the circle P₂). The operator senses the repulsive force and moves the cursor M against the repulsive force, and thus the operator can intuitively understand the establishment of connection to the apparatus of another operator to prevent improper establishment of connection. Furthermore, because the states of the other apparatuses are displayed as the circles P1 to P3, and the states thereof are changed corresponding to the connection state as shown in FIGS. 21 and 22, the operator can intuitively understand the connection state by viewing the image to prevent improper establishment of connection.

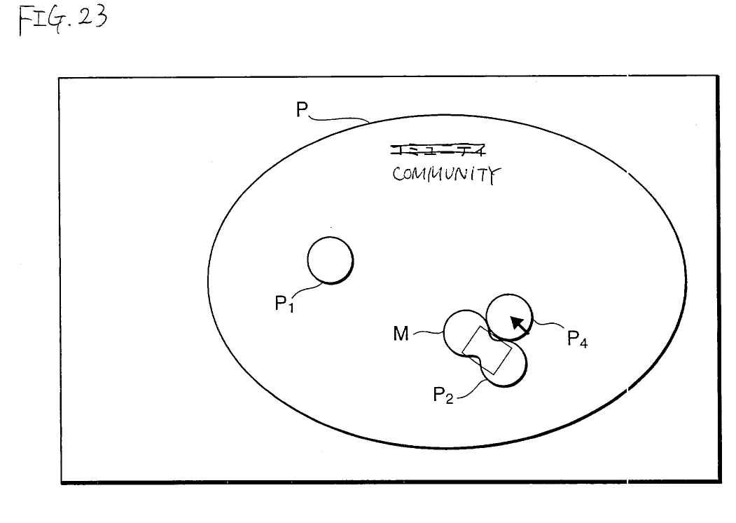

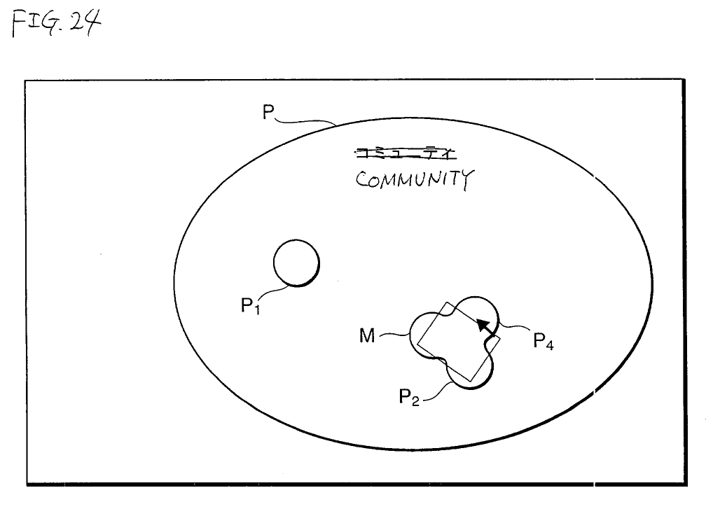

Furthermore, in the state where the apparatuses of the operators represented by the cursor M and the circle P₂ are connected to each other, when an apparatus of still another operator represented by the circle P₄ attempts to establish connection as shown in FIG. 23, a repulsive force from the circle P₄ toward the cursor M is presented to the movable member 112 of the device 100 of the operator. Similarly, a repulsive force from the circle P₄ toward the circle P₂ is presented to the apparatus of the operator represented by the circle P₂. A repulsive force from the midpoint between the cursor M and the circle P₂ toward the circle P₄ is presented to the apparatus of the operator represented by the circle P₄. In the case where all the operators make operation against the repulsive forces, the cursor M, the circle P₂ and the circle P₄ can be unified (i.e., the apparatuses of the three operators are connected to each other) as shown in FIG. 24. The operators sense the repulsive forces and make operation against the repulsive forces, and thus the operators can intuitively understand the establishment of connection to the apparatuses of the three operators to prevent improper establishment of connection.

As described in the foregoing, the image displaying device 55 displays an image presenting the states of other apparatuses that can be connected through the network. The connection state presenting means inside the main unit 50 changes the image displayed on the image displaying device 55 corresponding to the connection state or changes the image corresponding to the input instruction received by the device 100 (i.e., the position of the cursor M). It is also preferred that the connection state presenting means outputs audio corresponding to the connection state from the audio output device 56. According to the constitution, establishment of connection can be intuitively understood to prevent improper establishment of connection.

It is also preferred that the cursor M is displayed at the position on the screen of the image displaying device 55 based on the input instruction received by the device 100, and the connection state upon communicating another apparatus through the network is changed based on the position of the cursor M on the screen. It is also preferred that an image representing another apparatus capable of being connected through the network is displayed on the screen of the image displaying device 55 and haptic stimulation corresponding to the relative positional relationship between the image representing another apparatus and the position of the cursor on the screen is presented to the movable member 112 by the connection state presenting means. It is also preferred that the movable region of the cursor M on the screen of the image displaying device 55 is restricted based on the haptic stimulation presented to the movable member 112.

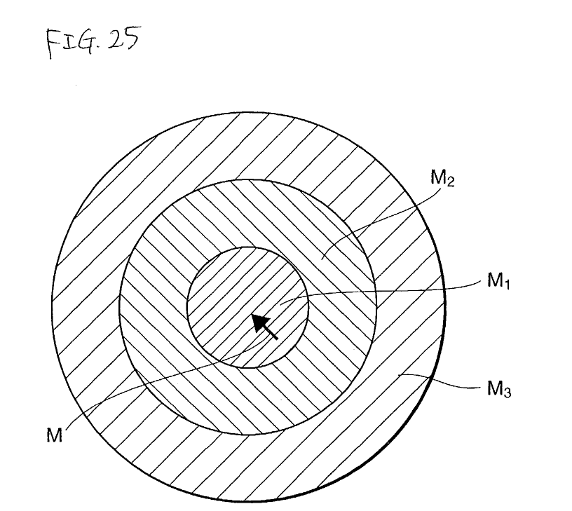

For example, furthermore, it is also possible that regions M₁ to M₃ are set up around the cursor M on the screen of the image displaying device 55 as shown in an example of a screen shown in FIG. 25, in which an attractive force to the symbols representing another apparatus (for example, the circles P₁ to P₃) (i.e., thrust in the direction toward the cursor M) is presented to the movable member 112 in the outermost region M₃, a repulsive force against the symbols representing another apparatus (i.e., thrust in the direction leaving from the cursor M) is presented to the movable member 112 in the region M₂ inside the region M₃, and an attractive force to the symbols representing another apparatus is presented to the movable member 112 in the innermost region M₁. The entry of another apparatus into the region M₃ is possible by an intent of only one of them, and the connection in that region enables communication between the apparatuses, but the mode of the communication is restricted (for example, audio communication is allowed but video communication is restricted). The apparatuses can enter the region M₁, respectively, by operating the movable members 112 of both the apparatuses in the region M₂ against the repulsive forces, and the connection in the region M₁ enables unrestricted communication between the apparatuses. Since the mode of connection is multistage, input instructions for connection in the respective stages becomes necessary associated thereto, and different kinds of stimulation are presented in the respective stages, with images corresponding thereto being displayed on the image displaying device 55.

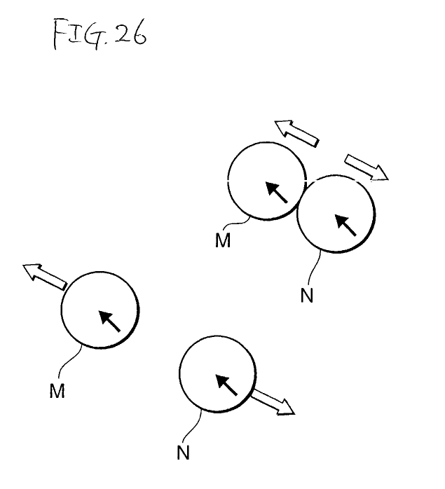

Furthermore, in the case where a cursor M of one apparatus and a cursor N of another apparatus attempt to be connected to each other as shown in an example of a screen shown in FIG. 26, it is possible that the cursor M is made collide with the cursor N on the screen to move the cursor N. It is preferred upon the collision that forces representing an impact upon the collision are presented to the movable members 112 of the apparatuses corresponding to the cursor M and the cursor N. It is possible that the connection between the apparatuses is established in the case where such a state is maintained for a prescribed period of time that the cursor M and the cursor N are made toward the positions of each other by the operation of the movable members 112 of the apparatuses. In the state where the apparatuses are connected to each other, on the other hand, it is possible that the connection between the apparatuses is released in the case where such a state is maintained for a prescribed period of time that the cursor M and the cursor N are made repulsive each other by the operation of the movable members 112 of the apparatuses.

(Embodiment of Information Processing System)

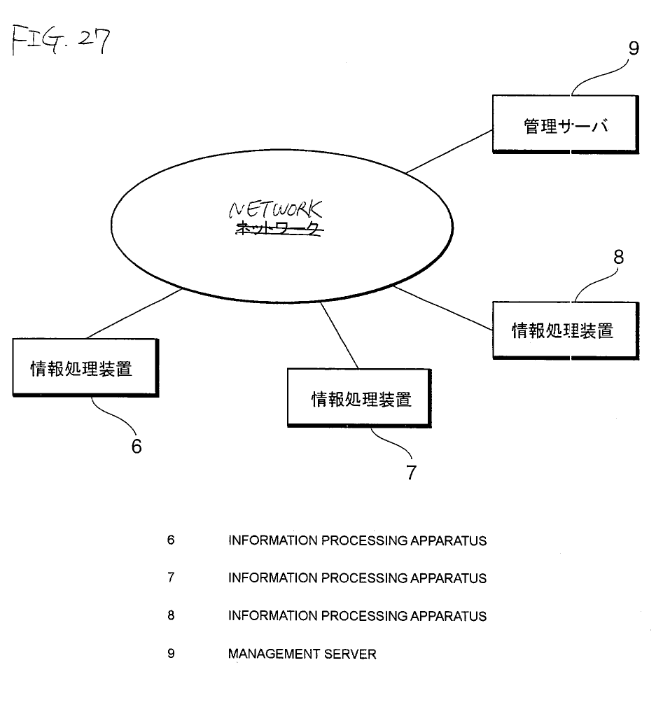

An information processing system containing a plurality of the information processing apparatuses described in the foregoing connected to a network will be described. FIG. 27 is a block diagram showing an information processing system according to this embodiment. The information processing system shown in the figure contains information processing apparatuses 6 to 8 and a management server 9, which are connected to a network. The information processing apparatuses 6 to 8 are those each according to one of the embodiments described in the foregoing. The management server 9 manages communications among the information processing apparatuses 6 to 8.

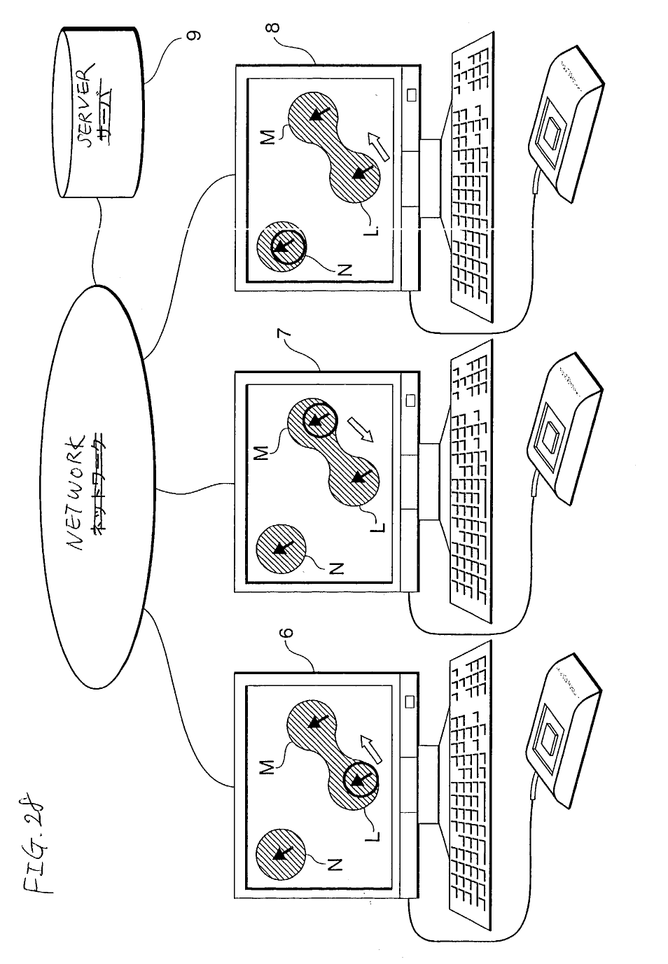

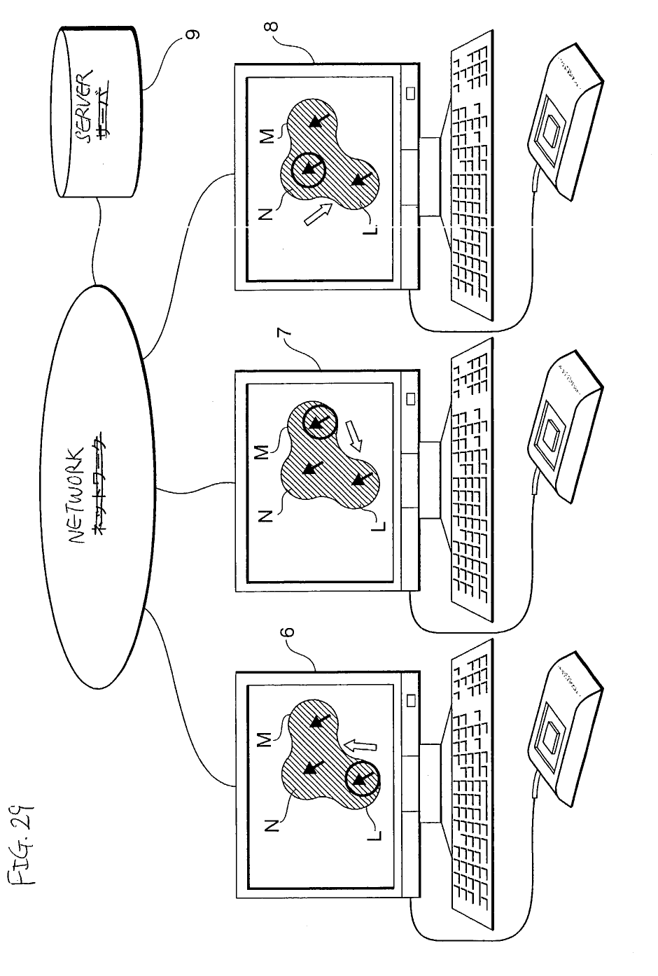

FIGS. 28 and 29 are diagrams showing examples of images displayed on the image displaying devices of the information processing apparatuses 6 to 8 contained in the information processing system according to this embodiment. As shown in these figures, the image displaying devices of the information processing apparatuses 6 to 8 display substantially the same images. In the respective screens, a cursor L represents the information processing apparatus 6, a cursor M represents the information processing apparatus 7, and a cursor N represents the information processing apparatus 8. On the screen of the information processing apparatus 6, its own cursor L is displayed distinctly from the other cursors. On the screen of the information processing apparatus 7, its own cursor M is displayed distinctly from the other cursors. On the screen of the information processing apparatus 8, its own cursor N is displayed distinctly from the other cursors.

In the example of an image shown in FIG. 28, the cursor L and the cursor M are unified with each other, i.e., it indicates that connection between the information processing apparatus 6 and the information processing apparatus 7 is established. The cursor N is disengaged from the other cursors L and M, i.e., it indicates that the information processing apparatus 8 is connected to the network but is not connected to the other information processing apparatuses 6 and 7. Consequently, all the apparatuses connected to the network are displayed on the image displaying devices of the information processing apparatuses 6 to 8, respectively, and the connection state among them is also displayed.

Under the foregoing state, a repulsive force is formed between the cursors L and M and the cursor N, i.e., a repulsive force is presented to the information processing apparatuses 5 and 6 and the information processing apparatus 7, respectively. In the case where such an operation is carried out that the cursors are made approach each other against the repulsive force, three cursors L, M and N are unified, and connection among the three information processing apparatuses 6 to 8 is established. Under the state where the three cursors L, M and N are unified, and connection among the three information processing apparatuses 6 to 8 is established, on the other hand, when such an operation is carried out that one of the cursors is released from other cursors, the connection between the apparatuses is released.

As described in the foregoing, according to the information processing system of this embodiment, the procedures for establishing (or releasing) connection can be intuitively understood in the respective information processing apparatuses, so as to prevent improper establishment (or release) of connection.

As described in detail in the foregoing, according to the invention, upon making an input instruction to the input device through an operation by an operator, communication is carried out through the network based on the input instruction received by the input device. Upon carrying out communication, haptic stimulation is presented by the stimulation presenting device corresponding to the connection state to the connected site through the connection state presenting means. The operator can receive the haptic stimulation presented by the stimulation presenting device, whereby the operator can intuitively understand the procedures for establishing (or releasing) the connection to prevent an improper establishment (or release) of connection.

What is claimed is:

1. An information processing apparatus for communicating with another apparatus through a network,
the information processing apparatus comprising:
an input device for receiving an input instruction;
a stimulation presenting device for presenting haptic stimulation; and
a connection state presenting means for presenting haptic stimulation, which corresponds to a connection state with a connected apparatus, to the stimulation presenting device, upon communicating through the network based on the input instruction received by the input device.

2. An information processing apparatus as claimed in claim 1, wherein
the input device receives a movement of a movable member as the input instruction, and
the stimulation presenting device presents the movement of the movable member as the haptic stimulation.

3. An information processing apparatus as claimed in claim 1, wherein
the apparatus further comprises an image displaying device for displaying an image, and
the connection state presenting means displays an image corresponding to the connection state on the image displaying device.

4. An information processing apparatus as claimed in claim 1, wherein
the apparatus further comprises an audio output device for outputting audio, and
the connection state presenting means outputs audio corresponding to the connection state from the audio output device.

5. An information processing apparatus as claimed in claim 1, wherein
the stimulation presenting device is capable of presenting multistage or multidimensional haptic stimulation, and
the connection state presenting means presents a certain stage of dimensional haptic stimulation corresponding to the connection state to the stimulation presenting device.

6. An information processing apparatus as claimed in claim 1, wherein the input device is capable of receiving a multistage or multidimensional input instruction.

7. An information processing apparatus as claimed in claim 3, wherein
the image displaying device displays an image presenting a state of the apparatus connected through the network, and
the connection state presenting means changes the image displayed on the image displaying device corresponding to the connection state.

8. An information processing apparatus as claimed in claim 3, wherein
the image displaying device displays an image presenting a state of the apparatus connected through the network, and
the connection state presenting means changes the image displayed on the image displaying device corresponding to the input instruction received by the input device.

9. An information processing apparatus as claimed in claim 1, wherein
the input device further comprises an image displaying device for displaying a cursor at a position on a screen based on the input instruction received by the input device, and
the connection state upon communicating the apparatus connected through the network is changed based on the position of the cursor on the screen.

10. An information processing apparatus as claimed in claim 9, wherein
the image displaying device displays an image presenting the apparatus connected through the network, and
the connection state presenting means presents haptic stimulation corresponding to a relative positional relationship between the image presenting the apparatus and the position of the cursor on the screen to the stimulation presenting device.

11. An information processing apparatus as claimed in claim 10, wherein the image displaying device restricts a movable region of the position of the cursor on the screen based on the haptic stimulation presented by the stimulation presenting device.

12. An information processing system comprising a plurality of information processing apparatuses as claimed in claim 1 connected to a network.
